(19) United States
(12) Patent Application Publication
(10) Pub. No.: US 2024/0185642 A1
(43) Pub. Date: Jun. 6, 2024

(54) METHOD FOR PROVIDING CONTEXT-DEPENDENT INFORMATION ABOUT AND/OR PAYING FOR ROAD SECTIONS SUBJECT TO A TOLL, AND SYSTEM

(71) Applicant: MERCEDES-BENZ GROUP AG, Stuttgart (DE)

(72) Inventors: Jörg ECHARD, Sindelfingen (DE); Martin KEPPLER, Oberreichenbach (DE)

(21) Appl. No.: 18/284,960

(22) PCT Filed: Mar. 16, 2022
(86) PCT No.: PCT/EP2022/056826

§ 371 Date: Sep. 29, 2023

(30) Foreign Application Priority Data
Mar. 30, 2021 (DE) 10 2021 001 674.2

(51) Int. Cl. G07B 15/06

(52) U.S. Cl. CPC G07B 15/063

(57) ABSTRACT

A method for providing context-dependent information about and/or paying for road sections subject to a toll on a route that is used by a vehicle. Information relating to the use of at least one road section subject to a toll is transmitted to a billing service provider authorized to bill for the payment. A current vehicle position and a current direction of travel of the vehicle are compared with a digital road map in order to detect when the vehicle approaches a road section subject to a toll, and, by manual call-up or when it is detected that the vehicle is approaching the road section subject to a toll, information characterizing the road section is displayed on a display in the vehicle, and/or an authorization to use the road section subject to a toll is obtained from the billing service provider.

### BACKGROUND AND SUMMARY OF THE INVENTION

Exemplary embodiments of the invention relate to a method and system for providing context-dependent information and/or paying for road sections subject to a toll on a route that is used by a vehicle.

Maintenance and expansion of a road traffic network is associated with high costs. To cover these costs, authorities or service providers commissioned for the operation of the road traffic network can raise fees for using individual road sections of the road traffic network. These include, for example, toll fees or costs incurred for using a designated low emission zone. Such a low emission zone fee is to be paid, for example, in the region of London, through the London Congestion Charge. Toll fees are typically collected in a manner specific to the vehicle type—for example, cars are subject to lower toll fees than trucks. In addition, country-specific differences exist in the manner in which toll fees are collected and paid. In some countries, a vignette obligation applies. For example, a vignette is to be applied visibly on a vehicle interior of a windshield of a vehicle, and allows a temporary use of road sections which are subject to a toll. In this case, a vignette is typically valid for a period of a few days, weeks or a year. In other countries, payment stations are located at the end of a road section subject to a toll, it being provided that the fee required for using the respective road section is paid directly after the road section subject to a toll has been used.

The different tariffs applicable in different countries for using road sections subject to a toll increase the complexity when planning a journey through these countries. For example, the person must find out which road sections are subject to which fees, and how they are to be paid. The requirement to attach a vignette to a vehicle is also associated with increased effort.

DE 10 2005 015 693 A1 discloses a method and device for the automated route registration allowing the payment of a toll required for using a route. For this purpose, a destination is input into a navigation device, whereupon the navigation device determines a route extending from a position of a vehicle to the destination. A route analysis device then checks whether the route comprises at least one road section subject to a toll. The route analysis device transmits the route to a toll system and/or a customer-specific control device so that a person driving the vehicle can check whether a service provider collecting the toll has correctly calculated the toll. If there is an unplanned change in the route or at least one road section during travel, the route analysis device checks which road sections of the original route are now no longer used, and which road sections are added to the route instead. Accordingly, road sections not used are canceled and the newly added road sections are registered for the toll collection. The method and the device for automated route registration allow for convenient collection and payment of toll fees. However, it is disadvantageous in this case that a route must be programmed into a navigation device beforehand for the toll collection. In addition, a person driving the vehicle cannot obtain information about incurred toll costs before using a road section subject to a toll. Thus, only after the entire route has been used, a toll fee is due, which corresponds to the individual road sections subject to a toll.

Exemplary embodiments of the present invention are directed to an improved method for providing context-dependent information about and/or paying for road sections subject to a toll on a route traveled by a vehicle, with the aid of which a person driving a vehicle is informed in a particularly simple and convenient manner of road sections which are subject to a toll, and/or can pay fees due from using a corresponding road section.

In a method for providing context-dependent information about and/or paying for road sections subject to a toll, of the type mentioned at the outset, according to the invention a current vehicle position and a current direction of travel of the vehicle are compared with a digital road map in order to detect an approach of the vehicle to a road section subject to a toll. In particular, during the approach of the vehicle, a distance of the vehicle from the road section subject to a toll is determined so that the approach is detected when a minimum distance is not met. This can take place by measuring/determining the distance between the current vehicle position on the digital map and the road section or a region subject to a toll. By manual call-up or upon detection of the approach of the vehicle to the road section subject to a toll, the information characterizing road section subject to a toll is displayed on a display in the vehicle, and/or an authorization for using the road section which is subject to a toll is obtained from the billing service provider.

With the aid of the method according to the invention, it is made possible, in a particularly simple and convenient manner, for a person driving a vehicle to view information about road sections subject to a toll and, if necessary, to adjust costs incurred by using such a road section subject to a toll. It is thus possible to inform a person driving a vehicle about possibly arising fees, even if the person driving the vehicle has not programmed a route into a navigation device of the vehicle, i.e., that the navigation device has no active destination guidance, which is provided according to a preferred embodiment of the invention. For determining the current vehicle position, for example a global navigation satellite system such as GPS can be used. By comparing the vehicle position with the digital road map, the road which the vehicle is using, and in which direction, is determined. If, for example, a corresponding road has at least one road section subject to a toll, ahead in the direction of travel of the vehicle, the corresponding information is displayed on the display of the vehicle. The display can be any desired display, such as an instrument cluster, a head unit, a head-up display, a display of an infotainment system, or the like.

For outputting the information, it is not absolutely necessary for the vehicle to be heading directly to a road section subject to a toll. For example, the information can also be output if the vehicle falls below a minimum distance from a road section subject to a toll, for example 10 km. For this purpose, the vehicle can, for example, also travel on a road that does not lead directly to the road section subject to a toll, but which runs, for example, in parallel therewith or leads past it. Since, in this case, there is also the likelihood of the vehicle turning off in order to soon enter a road section subject to a toll, relevant information can thus be presented to the person driving the vehicle at an early stage.

The person driving the vehicle can also actively request the information by inputting an operating action into a corresponding device on which the information is presented. This increases the comfort for the person driving the vehicle, since they can thus see the information at a time suitable for them.

For example, the following information can be presented here: a road course of the road section subject to a toll, conditions relevant for collection of the fees, for example toll fees dependent on vehicle type or number of people, possible payment methods or the like. If it is necessary to acquire a physical permit, for example in the form of a vignette, for driving the road section subject to a toll, the information can also comprise an indication of where possible sales points are located close to the current vehicle position and at what opening times they are open. A duration of validity of an authorization to use the road section subject to a toll can also be output.

In addition to the outputting of information, the authorization to use the road section subject to a toll can also be acquired from the billing service provider. If this is desired, for example, by the person driving the vehicle, a corresponding option for acquiring the authorization can be displayed on the display. By inputting an operating action, the person driving the vehicle is then able to confirm or reject the acquisition of the authorization. The person driving the vehicle can then input data required for this purpose via a corresponding device for inputting operating actions, for example a touchscreen. The information is then transmitted wirelessly to the billing service provider directly from the vehicle. It is also possible for data traffic to run over a service provider connected between the vehicle and the billing service provider. In order to further improve comfort for the person driving the vehicle, the authorization can also be acquired automatically from the billing service provider, for example when the vehicle enters a road section subject to a toll. Data required for this purpose can have been stored in advance in a corresponding device of the vehicle, so that the person driving the vehicle does not have to re-enter the required data every time.

After the transaction has been completed, information, for example in the form of a booking confirmation, can be issued by acquiring the authorization. In this case, an identification feature of the vehicle is stored with the billing service provider or an operator of the road section subject to a toll, on the basis of which a corresponding authorization can be assigned to the vehicle when the vehicle wishes to enter the road section subject to a toll. This can be, for example, an identifier or a chassis number of the vehicle, or the like. However, if it was not possible to acquire the authorization, for example due to a data transmission error, then an error message can also be output in this regard.

In this case, information about road sections subject to a toll that have been used in the past can also be stored in the vehicle, for example a name of the corresponding road section subject to a toll, a purchase price, a confirmation code, a duration of a validity, or the like, in order to enable a person driving a vehicle to be able to later on also still track transactions made.

An advantageous development of the method provides that at least a portion of the information characterizing a road section subject to a toll is visualized graphically in a digital road map. In addition to a representation of the information in text form, and/or enriched by static and/or animated symbols, it is also possible for road sections subject to a toll to be displayed in a digital road map of a navigation system. For example, road sections that are free of charge can be represented yellow, and road sections that are subject to a toll can be red. If an authorization to use a road section subject to a toll was already acquired, then such a red road section can also be displayed green, for example, in order to indicate to a person driving a vehicle, in a particularly intuitive manner, that no further fees are incurred for using the road section subject to a toll that is marked green.

A further advantageous embodiment of the method provides that the use of a route comprising at least one road section subject to a toll has an advantage over using a road section that is completely free of charge, information about the advantage resulting from using the road section subject to a toll being output. In this case, the information relating to the advantage can be displayed analogously on the display in the vehicle. As a result, a person driving a vehicle can be prompted to use a road section subject to a toll, even if this was originally not planned. It is therefore generally conceivable that, for example, the billing service provider grants discounts for a road section subject to a toll if a certain number of kilometers has been covered on a road section subject to a toll, and/or a corresponding road section subject to a toll has been used with a certain frequency, for example twenty times in the month. If the person driving the vehicle is still lacking for example 10 kilometers and/or two uses of the road section subject to a toll, then the person driving the vehicle can redeem this in order to obtain a discount. Such a discount can also be granted, for example, if a time required for traveling a road section subject to a toll is greater than a time typically required for this, for example due to congestion and/or construction work.

According to a further advantageous embodiment of the method, the advantage is that the route subject to a toll can be covered in a shorter time than the route that is free of charge, and/or that the route subject to a toll has a shorter path length than the route that is free of charge. Thus, it is necessary for the person driving the vehicle to pay for using the route subject to a toll, but, in return, they can reach their desired destination more quickly. In this case, if the route subject to a toll has a shorter path length than the route that is free of charge, the person driving the vehicle also saves fuel costs, since the vehicle requires less fuel. This at least partially compensates for the fee for using the route subject to a toll. Similarly, a corresponding vehicle emits fewer emissions in order to arrive at a journey destination.

A further advantageous embodiment of the method further provides that at least one item of additional information is output together with the information about the advantage, in particular additional information about various available purchase options for the authorization for using the road section subject to a toll. For example, the billing service provider can offer different authorizations for a specific road section subject to a toll. The authorizations can differ, for example, in a validity period with which they authorize the person driving the vehicle to use the road section subject to a toll. For example, a first validity period may be one day, a second validity period one week, and a third validity period one month. If the person driving the vehicle knows that they have to drive the road section subject to a toll several times within a certain period of time, then the person driving the vehicle can acquire an authorization for using the road section subject to a toll that is valid for an appropriate period of time. In this case, it can be provided that the costs incurred for one day for an authorization valid for a longer period are lower than the costs incurred for one day for an authorization valid for a shorter period. In general, however, the additional information can also comprise any information, for example a current traffic volume on the road section subject to a toll. If, for example, there is congestion on the route that is free of charge, and the route subject to a toll is free, the person driving the vehicle can decide to choose the route subject to a toll, in order to arrive at their destination.

According to a further advantageous embodiment of the method, at least one road section subject to a toll is located on a planned travel route of the vehicle, the approach of the vehicle to the section subject to a toll already being identified when planning the route. Thus, the advantages achieved with the aid of the method according to the invention can also be used for planned travel routes, for example a travel route planned by means of a navigation device.

A further advantageous embodiment of the method further provides that data relevant for the use of the road section subject to a toll are collected from a service provider and transmitted to the billing service provider. This improves comfort for the person driving the vehicle even further when the vehicle is used, since steps associated with outlay for the authorization for using a road section subject to a toll are performed by the service provider. The relevant data comprises, for example, a characteristic and/or emission values of the vehicle, as well as a vehicle type, for example a passenger car, truck, or also a drive type, for example a vehicle having an internal combustion engine, a hybrid vehicle, or an electric vehicle. The relevant data can also comprise, for example, whether or not the vehicle has a trailer, or how many persons are currently being transported in the vehicle. In this case, the relevant data can be stored with the service provider before the start of a journey. Thus, it is not necessary for the person driving the vehicle to themselves transmit the data to the billing service provider before using the road section subject to a toll. This improves convenience, in particular during travel. In particular, blockchain technology can be used to transmit data. The service provider can be, for example, a vehicle manufacturer or an authority such as a registration office or a road maintenance depot. In this case, the service provider can also be outsourced, for example as a subsidiary of the vehicle manufacturer. The service provider can provide its own infrastructure, such as Internet servers and wireless communication devices. A communication between the service provider and billing service provider preferably takes place via the Internet. This ensures reliable and rapid transmission of the relevant data.

The relevant data can also be transmitted automatically. For example, the relevant data is stored in the vehicle and is transmitted from the vehicle to the service provider a following receipt of a request signal from the service provider. An authentication may also be required for this purpose. It is also conceivable that the person driving the vehicle determines criteria for when the relevant data may be transmitted to the service provider. For example, the relevant data may be transmitted to the service provider only if the service provider grants a discount for using the road section which is subject to a toll.

The payment for authorization for using the road section subject to a toll is preferably billed via the service provider. For this purpose, payment information, for example an IBAN of the person driving the vehicle, can be stored with the service provider. The service provider accordingly forwards the payment information to the billing service provider. Since the person driving the vehicle thus does not have to worry about the payment for the authorization for using the road section subject to a toll, convenience for the person driving the vehicle can be yet further improved.

In the case of a system consisting of at least a vehicle, an arithmetic unit, a navigation device, and a wireless communication device, the vehicle, the arithmetic unit, the navigation device, and the wireless communication device are configured to carry out a method described above. The vehicle is any vehicle, such as a passenger car, truck, transporter, bus or the like. The vehicle can have a central on-board computer, a telematics unit, a separate arithmetic unit, a control device of a vehicle subsystem, or the like, as the arithmetic unit. In this case, the navigation device can also be integrated into the arithmetic unit. In particular, the navigation device is a navigation system based on global navigation satellite systems such as GPS. The navigation system can be fixedly integrated in the vehicle, or can be designed to be mobile. The wireless communication device enables wireless communication between the vehicle, the billing service provider and/or service provider. For this purpose, any wireless communication technology, for example radio, in particular mobile radio, can be used. In general, wireless communication is also possible, for example, via WiFi, Bluetooth or the like. In general, it is also conceivable for the arithmetic unit, the navigation device and/or the wireless communication device to comprise a mobile terminal such as a smartphone.

According to a further advantageous embodiment of the system, at least one arithmetic unit is designed as an arithmetic unit inside the vehicle and/or a central processing unit external to the vehicle. In this case, a central processing unit external to the vehicle is understood in particular to mean a server of the service provider. This is, in particular, connected to the Internet. Thus, the vehicle can transmit its current vehicle position to the central processing unit external to the vehicle, whereupon the unit checks whether the vehicle is approaching a road section subject to a toll, and, if this is the case, can transmit the information and/or the possibility of acquiring an authorization for using the road section subject to a toll back to the vehicle. In this case, data relevant for acquiring the authorization are advantageously stored on the central processing unit external to the vehicle. The storage of the relevant data on the central processing unit external to the vehicle can, for example, also have been completed conveniently, by the person driving the vehicle, from home, before the start of the journey. In this case, the relevant data can be input via a mobile terminal and/or a desktop computer, which communicates with the service provider for example via the Internet.

The system preferably comprises an identification device for wireless identification of the vehicle. This is, for example, a transmitting device that emits an identifier identifying the vehicle. The transmitter can transmit the identifier by means of electromagnetic waves, for example by microwaves, radio, light or the like. The identifier can, for example, be stored digitally in a memory of an arithmetic unit. The identification device can also be formed by a transponder. With the aid of the identification device, a particularly comfortable checking of the authorization for using the road section which is subject to a toll is possible, since this eliminates the provision of physical authorizations, for example in the form of a vignette.

In a broader sense, an identifier of the vehicle can also be understood as an identification device. For example, nowadays identifiers of vehicles are often already detected with the aid of cameras, whereupon a check is made in a system operated by the billing service provider as to whether an authorization for using a road section subject to a toll has been stored for the corresponding identifier.

In particular by providing various identification devices, it can be ensured that an automatic identification of the vehicle is made possible at different elevation or control locations of road sections subject to a toll, by means of different operators of the respective road sections. This reduces the risk that the person driving the vehicle has to attach a physical identification feature, for example a vignette, to the vehicle when using a specific road section subject to a toll, the billing service provider of which does not enable wireless identification of the vehicle.

Further advantageous embodiments of the method according to the invention for providing context-dependent information and/or payment for road sections subject to a toll, and of the system, also result from the embodiments which are described in more detail below with reference to the figures.

### BRIEF DESCRIPTION OF THE DRAWING FIGURES

In the figures:

FIG. 1 shows a schematic view of a vehicle moving forward in a road traffic network; and

FIG. 2 shows a schematic plan view of a vehicle comprising a system according to the invention for providing information about and/or paying for road sections subject to a toll.

### DETAILED DESCRIPTION

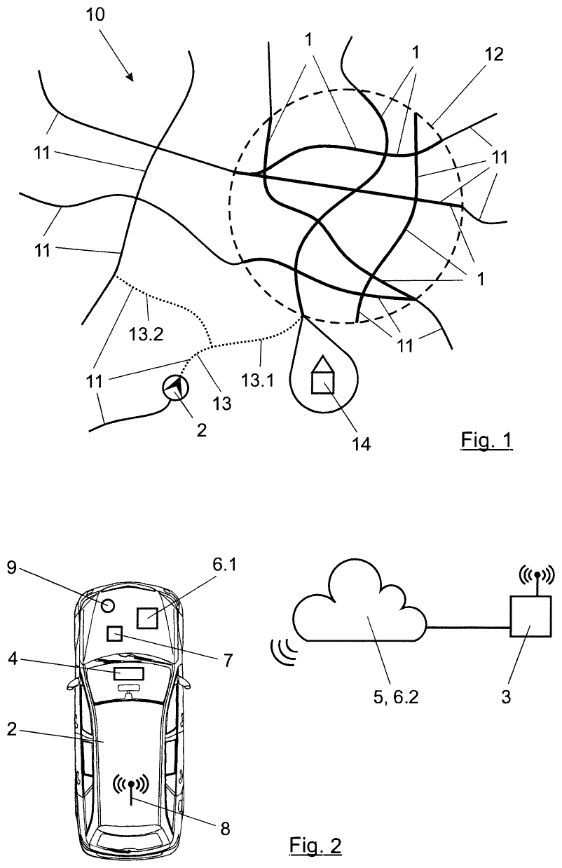

FIG. 1 shows a road traffic network 10 composed of a plurality of different roads 11. The road traffic network 10 comprises a region 12 subject to a toll, the roads 11 of which are formed by road sections 1 which are subject to a toll. The road sections 1 subject to a toll or the region 12 subject to a toll is, for example, a freeway for which a toll is to be paid, a tunnel for which a tunnel toll is to be paid, a city region for which a city toll is to be paid, a low emission zone for which an emissions fee is to be paid, or the like.

A vehicle 2 approaches the region 12 subject to a toll. The vehicle 2 comprises a navigation device 7, shown in FIG. 2, which determines the road 11 on which and the direction in which the vehicle 2 is traveling by comparing a geo-position of the vehicle with digital map material. It is thus also possible to identify/determine whether the vehicle 2 falls below a predetermined minimum distance from the region 12 or from a road section 13.1 subject to a toll, so that it can be assumed that the vehicle 2 is entering the region. Since a road section 13 used by the vehicle 2 leads to the region 12 subject to a toll, there is the possibility that the vehicle 2 may have to soon pay a toll for using the region 12, which is subject to a toll. However, the road section 13 forks between the current position of the vehicle 2 and the region 12 subject to a toll, in a first 13.1 and a second road section 13.2. There is no information available regarding which of road sections 13.1 or 13.2 the vehicle 2 will take, in particular if no destination guidance is activated in the navigation device 7, i.e., no travel route is input. The second road section 13.2 leads around the region 12 subject to a toll, so that the vehicle 2 does not have to pay a toll.

Since there is a possibility that the vehicle 2 may enter the region 12 subject to a toll, information about the region 12 subject to a toll or the road sections 1 subject to a toll that are included therein is displayed in the vehicle 2 on a display 4, likewise shown in FIG. 2, when the vehicle approaches the region 12 or falls below a predefinable minimum distance from the region 12. As a result, a person driving a vehicle 2 is informed, for example, of a name, fee conditions, incurred costs, possible payment methods, or the like, of the road section 1 subject to a toll. Since this information is displayed on the display 4 in a timely manner, the person driving the vehicle can decide, before reaching the fork, to bypass or enter the region 12 subject to a toll. The corresponding information is displayed automatically due to the analysis of the vehicle position, which increases comfort for the person driving the vehicle.

The information can also be manually retrieved by the person driving the vehicle by inputting an operating action, for example in a display 4 designed as a touchscreen.

The information can also be output before the start of the journey, for example in the step of route planning by means of the navigation device 7. In particular, the information and/or the possibility of acquiring an authorization for using a road section 1 subject to a toll is output if it is determined that the route comprises a road section 1 subject to a toll.

If the person driving the vehicle wishes to use the region 12 subject to a toll, various possibilities are thus available for acquiring an authorization for using at least one road section 1 subject to a toll. If a physical authorization is necessary for using the region 12 subject to a toll, for example a vignette, this must be acquired by the person driving the vehicle and can be mounted visibly on the vehicle 2. To easily enable the person driving the vehicle to acquire such physical authorization, the information shown on the display 4 can comprise, for example, a location of a payment point 14 for acquiring such a physical authorization, as well as opening times and/or a Web address or telephone number of the payment point 14. As a result, the person driving the vehicle is informed particularly conveniently about possibilities for acquiring the physical authorization.

Nowadays, in the case of a plurality of road sections 1 subject to a toll, it is no longer necessary to attach a physical authorization to a vehicle 2. For example, a digital authorization for using a road section 1 subject to a toll can be acquired, whereupon an operator of the region 12 subject to a toll checks, when the vehicle 2 arrives at the edge of the region 12 subject to a toll, whether the vehicle 2 has paid a corresponding toll and the may therefore use the region 12 subject to a toll. For this purpose, an identification feature is required to be able to assign an authorization to a vehicle 2. For example, for this purpose a characteristic of the vehicle 2 can be stored with the operator of the region 12 subject to a toll. Thus, for example, automated barriers can be attached to a payment point 14, the vehicles 2 moving towards the region 12 subject to a toll being detected with the aid of cameras, and the identifiers of the vehicles 2 being scanned. If information about a specific identifier is present, the automated barrier can open and release a path for the vehicle 2 into the region 12 subject to a toll. An identification by means of identifiers here merely represents an example. In general, an identification of the vehicle 2 can take place by means of any other proven method, for example with the aid of an identification device 9 shown in FIG. 2. This can be, for example, a transponder, microwave transmitter, or the like.

To further increase the comfort for the person driving the vehicle 2, it is made possible for the person driving the vehicle to automatically obtain the authorization for using the region 12 subject to a toll or at least one road section 1 subject to a toll. Thus, the vehicle 2 can send relevant data for acquiring the authorization directly or indirectly to the operator of the region 12 subject to a toll. These relevant data comprises, for example, a characteristic of the vehicle 2, emission values of the vehicle 2, a vehicle type such as a passenger car, truck, a vehicle with an internal combustion engine, or an electric vehicle, a trailer attached to the vehicle 2, a number of persons traveling in the vehicle 2, or the like. The relevant data can also comprise, for example, payment information such as an IBAN of the person driving the vehicle.

A communication between the vehicle 2 and the operator of the region 12 subject to a toll preferably takes place wirelessly, for example via radio. For this purpose, any radio technology, such as mobile radio, WiFi, Bluetooth, or the like, can be used. The relevant data can be stored in the vehicle 2 or input directly into the vehicle 2 by the person driving the vehicle for transmitting the relevant data.

It is also conceivable for the data and/or the payment information to be transmitted indirectly via a service provider 5. This is also shown in FIG. 2. The service provider 5 is, for example, an authority or a vehicle manufacturer. The service provider 5 provides infrastructure required for this, such as Internet servers.

The acquisition of the authorization for using at least one road section 1 subject to a toll can be confirmed before the acquisition by the person driving the vehicle 2. This prevents the person driving the vehicle from unintentionally paying money. Thus, information about a possible acquisition of the authorization, which the person driving the vehicle must approve by inputting a corresponding operating action, can be displayed on the display 4. The display of the request to acquire the authorization, or the automatic purchase of the authorization, can take place, for example, when the vehicle 2 falls below a critical distance from the region 12 subject to a toll. This is the case, for example, when the vehicle 2 has approached a corresponding pay point 14 to a distance of 50 m or less. In this case, sensor fusion can additionally also take place. For example, the vehicle 2 can have cameras (not shown), camera images generated by the cameras being evaluated by image recognition algorithms. If the payment point 14 is identified in at least one camera image, the authorization for using the region 12 subject to a toll can then be acquired automatically. It is also conceivable that the vehicle 2 communicates with the payment point 14 by means of a wireless communication interface 8, which is also shown in FIG. 2, and/or the identification device 9.

FIG. 2 shows a larger view of the vehicle 2. In addition to the display 4, the wireless communication interface 8, the identification device 9, and the navigation device 7, the vehicle 2 also comprises at least one arithmetic unit 6.1 inside the vehicle. In this case, it is also conceivable for the arithmetic unit 6.1 inside the vehicle to be integrated in the navigation device 7. However, the arithmetic unit 6.1 inside the vehicle can also be a separate arithmetic unit, a control device of a vehicle subsystem, a telematics unit, or the like. The vehicle 2 communicates via the wireless communication interface 8 with the service provider 5 and/or a billing service provider 3 authorized for billing for a road section 1 subject to a toll. In this case, the service provider 5 provides an infrastructure relevant for communicating between the vehicle 2 and the billing service provider 3, here in the form of a central processing unit 6.2 external to the vehicle, for example a Cloud server. The service provider 5 can communicate with the billing service provider 3 in a wired manner, for example. Preferably, communication takes place via the Internet.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-13. (canceled)

14. A method for providing context-dependent information about or paying for at least one road section subject to a toll on a route that is used by a vehicle, wherein information relating to use of the at least one road section subject to the toll is transmitted to a billing service provider authorized to bill for payment for use of the at least one road section subject to the toll, the method comprising:
comparing a current vehicle position and a current direction of travel of the vehicle with a digital road map to detect when the vehicle approaches the at least one road section subject to the toll; and
responsive to a manual call-up or when a result of the comparison is that the vehicle is approaching the at least one road section subject to the toll
displaying, on a display in the vehicle, information characterizing the at least one road section subject to the toll, or
obtaining, from the billing service provider, authorization to use the at least one road section subject to the toll.

15. The method of claim 14, wherein whether the vehicle approaches the at least one road section subject to the toll is determined based on whether there is a minimum distance from the vehicle to the at least one road section subject to the toll.

16. The method of claim 14, wherein the method is performed while a navigation device of the vehicle is in a state without active destination guidance.

17. The method of claim 14, wherein at least a portion of the information characterizing the at least one road section subject to the toll is graphically visualized in the digital road map.

18. The method of claim 14, wherein when use of a route comprising the at least one road section subject to the toll has an advantage over use of a route that is completely free of charge, information about the advantage resulting from the use of the route comprising the at least one road section subject to the toll is output.

19. The method of claim 18, wherein the advantage is that the route comprising the at least one road section subject to the toll can be covered in a shorter time than the route that is free of charge, or the advantage is that the route comprising the at least one road section route subject to the toll has a shorter travel distance than the route that is free of charge.

20. The method of claim 18, wherein at least one item of additional information is output together with the information about the advantage, wherein the at least one item of additional information relates to available purchase options for the authorization for using the at least one road section subject to a toll.

21. The method of claim 14, wherein the at least one road section subject to the toll is located on a planned route of the vehicle and the approach of the vehicle to the at least one road section subject to the toll is already detected when planning the route.

22. The method of claim 14, wherein relevant data for the use of the at least one road section subject to a toll is collected by a service provider and transmitted to the billing service provider.

23. The method of claim 22, wherein billing of the payment for the authorization to use the at least one road section subject to a toll is performed via the service provider.

24. A system, comprising:
a vehicle;
an arithmetic unit;
a navigation device; and
a wireless communication device,
wherein the vehicle, the arithmetic unit, the navigation device and the wireless communication device are configured to
compare a current vehicle position and a current direction of travel of the vehicle with a digital road map to detect when the vehicle approaches at least one road section subject to a toll; and
responsive to a manual call-up or when a result of the comparison is that the vehicle is approaching the at least one road section subject to the toll
display, on a display in the vehicle, information characterizing the at least one road section subject to the toll, or
obtain, from a billing service provider, authorization to use the at least one road section subject to the toll.

25. The system of claim 24, wherein the arithmetic unit is inside the vehicle.

26. The system of claim 24, wherein the arithmetic unit is external to the vehicle.

27. The system of claim 24, further comprising:
an identification device configured to wirelessly identify the vehicle.
